(19) United States
(12) Patent Application Publication
(10) Pub. No.: US 2026/0096539 A1
(43) Pub. Date: Apr. 9, 2026

(54) WEARABLE WIRELESS COMMUNICATOR

(71) Applicant: Clarissa Alison Cuevas, El Segundo, CA (US)

(72) Inventor: Clarissa Alison Cuevas, El Segundo, CA (US)

(21) Appl. No.: 18/908,827

(22) Filed: Oct. 8, 2024

(51) Int. Cl. A01K 27/00; A01K 15/02; A01K 29/00

(52) U.S. Cl. CPC A01K 27/009; A01K 15/023; A01K 15/029; A01K 27/001; A01K 29/005

(57) ABSTRACT

Aspects of the disclosure are directed to a wearable wireless communicator. In accordance with one aspect, the disclosure includes an imager configured to capture image data; a memory coupled to the imager, the memory configured to store the image data; a transceiver coupled to the imager and the memory, the transceiver configured to wirelessly transmit the image data to a remote device; a databus configured to transport the image data between the imager, the memory and the transceiver; and a housing for housing the databus, the imager, the memory and the transceiver, wherein the housing is attached to a collar portion, and wherein the collar portion is configured to fit around a body part of a wearer.

### TECHNICAL FIELD

This disclosure relates generally to the field of wireless communication, and, in particular, to a wearable wireless communicator.

### BACKGROUND

Pets such as dogs and cats are often treated as family members. But, there are many places that the pets cannot accompany their human family members. Thus, the pets are left at home, sometimes inside the house or inside a yard. Often, the human family members would like to know in real time what their pets are seeing and/or hearing, particularly if their pets are encountering a stressful event. Additionally, there's a need to monitor a child and/or a person with cognitive issues and/or mental decline.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a wearable wireless communicator which may be worn by a pet or a person. Accordingly, the present disclosure discloses an apparatus including: an imager configured to capture image data; a memory coupled to the imager, the memory configured to store the image data; a transceiver coupled to the imager and the memory, the transceiver configured to wirelessly transmit the image data to a remote device; a databus configured to transport the image data between the imager, the memory and the transceiver; and a housing for housing the databus, the imager, the memory and the transceiver, wherein the housing is attached to a collar portion, and wherein the collar portion is configured to fit around a body part of a pet.

In one example, the apparatus further includes a microphone housed within the housing, the microphone configured to receive a first sound energy and to convert the first sound energy to a first electrical energy. In one example, the transceiver is further configured to transmit the first electrical energy to the remote device.

In one example, the apparatus further includes a speaker housed within the housing, the speaker configured to convert a second electrical energy to a second sound energy, wherein the second sound energy is set at a volume that is audible. In one example, the transceiver is further configured to receive a wireless signal from the remote device and convert the wireless signal to the second electrical energy, and wherein the databus is further configured to transport the second electrical energy to the speaker.

In one example, the apparatus further includes a motion detection sensor coupled to the databus, the motion detection sensor configured to detect a motion level and further configured to turn ON one or more of the imager and the microphone when the motion level is above a preset motion threshold. In one example, the apparatus further includes an audio detection sensor coupled to the databus, the audio detection sensor configured to detect an audio level and further configured to turn ON one or more of the imager and the microphone when the audio level is above a preset audio threshold.

In one example, the apparatus further includes a processing engine coupled to the databus, the processing engine configured to process image data captured by the imager or audio data captured by the microphone. In one example, the apparatus further includes a GPS receiver coupled to the databus, the GPS receiver configured to provide a three-dimensional (3D) position of housing. In one example, the processing engine is further configured to use the 3D position to determine if the housing is within a set perimeter boundary.

In one example, the apparatus further includes a modem coupled to the databus, the modem configured to perform modulation on a source information signal to generate a transmit signal to be transmitted to the remote device. In one example, the apparatus further includes a support infrastructure with an electric shock feature, the support infrastructure coupled to the data bus and configured to deliver an electric shock to the collar portion. In one example, the electric shock is delivered only when the housing is not within the set perimeter boundary. In one example, the electric shock is delivered when triggered by a signal received from the remote device. In one example, the apparatus further includes a buckle, a clasp and a ring, each separately attached to a distinct area of the collar portion.

In one example, the apparatus further includes a modem coupled to the databus, the modem configured to perform demodulation on a receive signal from the remote device to generate a destination information signal. In one example, the transceiver is further configured to wirelessly receive a wireless signal from the remote device and to output a receive signal. In one example, the modem is further configured to demodulate the receive signal to generate a second electrical energy. In one example, the speaker is further configured to convert the second electrical energy to a second sound energy for communicating with the pet. In one example, the apparatus further includes a buckle, a clasp and a ring, each separately attached to a distinct area of the collar portion.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1A illustrates an example wearable wireless communicator.

FIG. 1B illustrates the example wearable wireless communicator in a linear view.

FIG. 1C illustrates an example of a dog wearing a wearable wireless communicator on a collar.

FIG. 1D illustrates an example, of a dog wearing a wearable wireless communicator on a harness.

FIG. 2 illustrates an example information processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

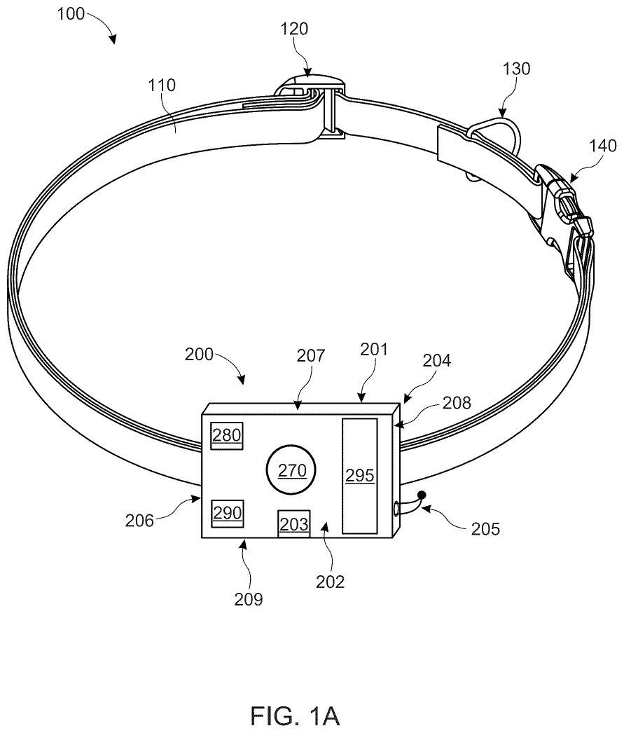

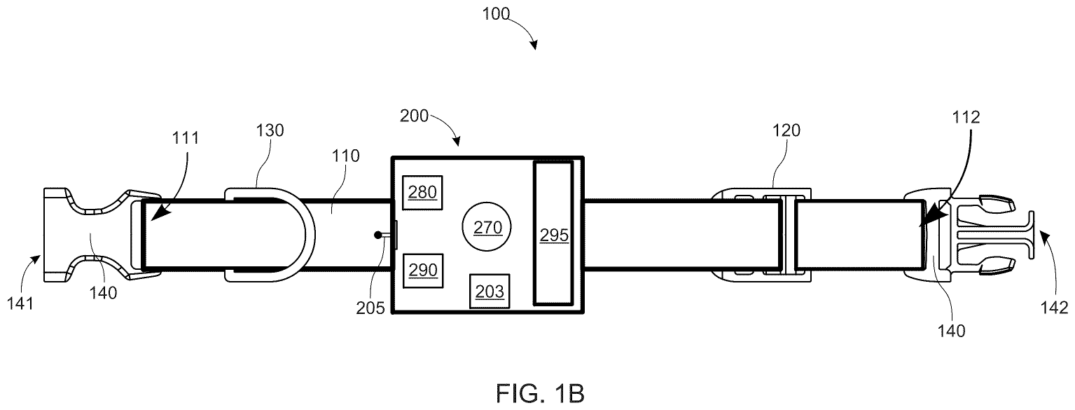

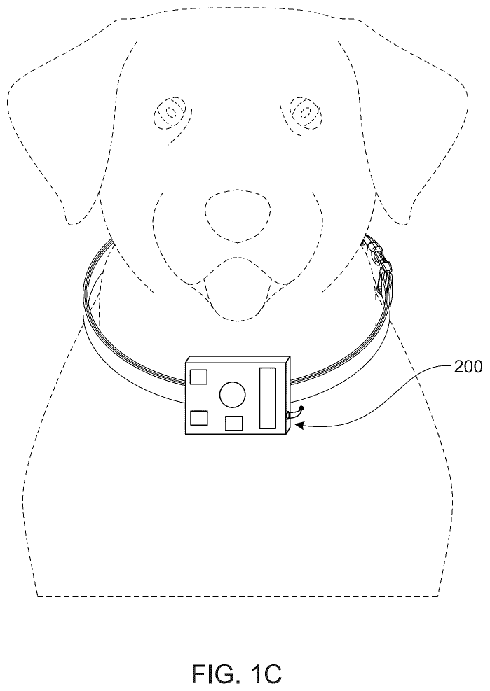

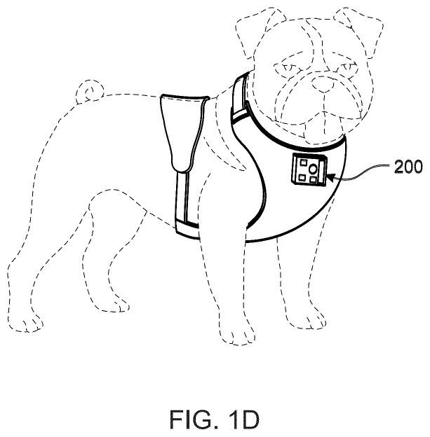

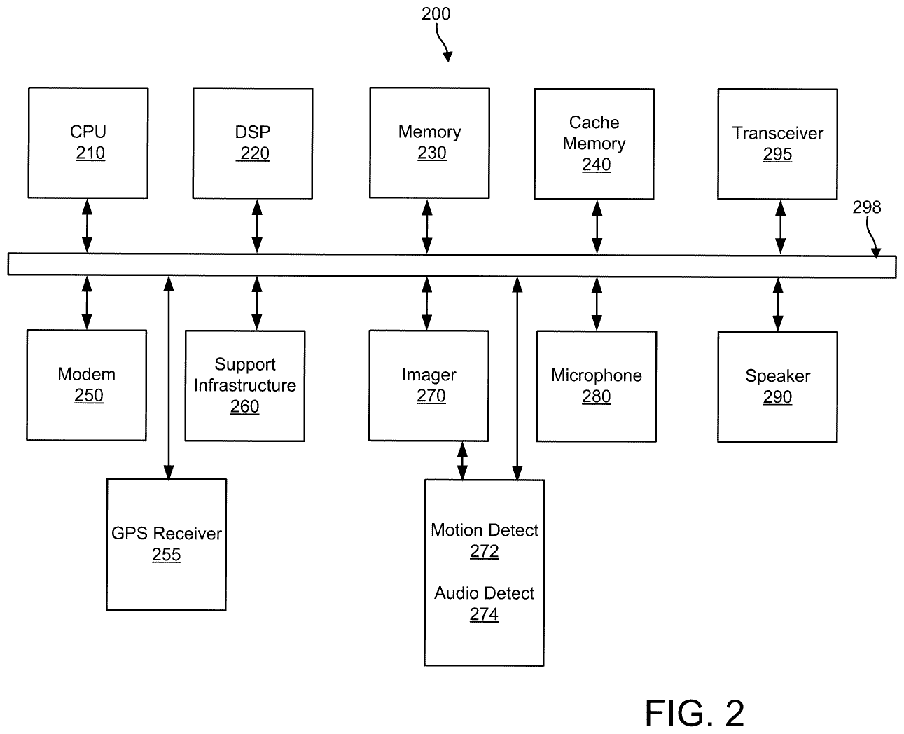

FIG. 1A illustrates an example wearable wireless communicator 100. In one example, the pet wireless communicator includes a collar portion 110, a buckle 120, a ring 130, a clasp 140 and an information processing system 200 (illustrated in FIG. 2). In one example, the collar portion has two ends, a first end 111 and a second end 112 (shown in FIG. 1B) such that when the first end 111 and the second end 112 are clasped together using the clasp 140, the collar portion is then secured around the pet's neck (or other body part). The clasp 140 includes two clasp points, a first clasp point 141 and a second clasp point 142. In securing the collar portion 110 around the pet's neck (or other body part), the second clasp point 142 fits into the first clasp point 141. FIG. 1B illustrates the example wearable wireless communicator 100 in a linear view. In one example, a pet may include a dog, a cat, or any domestically kept animal, which may include a rabbit, a chicken, a monkey, a baby bear, etc. In one example, the wearable wireless communicator may be worn by an animal kept at a zoo.

In one example, the collar potion 110 is made of cloth or metal material. One skilled in the art would understand that the collar portion may be made of any material that would be comfortable against the skin and/or fur of a pet. In one example, the collar portion has a thickness typical of a pet collar, such that the thickness varies according to the size and build of the pet that will wear the collar. Additionally, the collar portion's length is also dictated by the size and build of the pet that will wear the collar. In one example, the collar portion's length is adjustable. The third dimension of the collar portion (a.k.a. the width) is typical of neck collars for a pet, for example, between ½ inch to 2 inches, depending on the size and build of the pet that will wear the collar.

In one example, the wearable wireless communicator 100 includes a buckle 120 which functions to adjust the length of the collar portion so that wearable wireless communicator 100 may fit snuggly around a pet's neck area. One skilled in the art would understand that the wearable wireless communicator 100, although will likely be placed on a pet's neck area, it may also be worn on another body part of a pet, for example, a front leg or a rear leg. In one example, the buckle may be made of a metal alloy or a durable plastic material. However, one skilled in the art would understand that other materials may be used for the buckle as long as it has the sufficient strength to lock the collar portion at its desired length to fit the pet.

In one example, the wearable wireless communicator 100 includes a ring 130. The function of the ring 130 is to allow attachment of, for example, a leash. The ring may also function as a receptor for other attachments that a human member (e.g., a human family member) may want to attach to the wearable wireless communicator 100, for example, a name plate of the pet. In one example, the wearable wireless communicator 100 may include more than one rings 130. And, in one example, multiple rings 130 on the wearable wireless communicator 100 may be of different dimensions, depending on its intended attachments.

Although the wearable wireless communicator 100 is shown and described as being worn by a pet, it is also within the present disclosure's scope and spirit that the wearable wireless communicator may be worn by a person. For example, a child may wear the wearable wireless communicator 100 so that the child's location and what the child sees and/or hear may be monitored by another (e.g., a parent, a guardian, a babysitter, a caregiver, etc.). For example, a person with cognitive issues or mental decline (e.g., Alzheimer's disease, dementia, etc.) may wear the wearable wireless communicator 100 so that the person's location and what the person sees and/or hear may be monitored by another (e.g., a parent, a guardian, a babysitter, a caregiver, etc.).

FIG. 1C illustrates an example 300 of a dog wearing a wearable wireless communicator on a collar. Although the wearable wireless communicator is shown with a collar portion 110, one skilled in the art would understand that the wearable wireless communicator 100 may include other accessories (such as but not limited to a harness, a pet jacket, etc.) to make it wearable on a pet. For example, FIG. 1D illustrates an example, 400 of a dog wearing a wearable wireless communicator on a harness.

FIG. 2 illustrates an example information processing system 200 which is a component of the wearable wireless communicator 100. In one example, the wearable wireless communicator 100 includes an information processing system, such as the information processing system 200 illustrated in FIG. 2. In one example, the information processing system 200 is permanently attached to an area of the collar portion 110 or other parts of the collar portion, such as the ring 130. Although the information processing system 200 is permanently attached to the collar portion 110, in one example, it is attached in such a way as to allow changing the battery (not shown). For example, a window access 203 to the battery may be added to the front surface 202 (See FIG. 1A) In another example, the information processing system may be detached from the collar portion 110, for example, on occasions when it is desired to clean the collar portion or to replace the battery.

In one example, the information processing system 200 includes at least two processing engines such as a central processing unit (CPU) 210 and a digital signal processor (DSP) 220. In one example, the information processing system 200 includes other functional components such as a memory 230, a cache memory 240 for storage of data which may include video and audio recordings captured by the pet wireless communicator. For example, the memory 230 and/or the cache memory 240 may be shared among the CPU 210, the DSP 220 and any other processing engines that may be added to the information processing system 200.

The various components of the information processing system 200 are contained within a housing 201. In one example, the housing 201 includes a front surface 202 which is worn to face the same direction as a pet's vision. In one example, the housing 201 includes a position lock 205 to hold the information processing system 200 in position on the collar portion 110. Although the position lock 205 is illustrated on one side of the information processing system 200, one skilled in the art would understand that the position lock 205 may be located on any part of the housing 201, for example but not limited to, on one of the side surfaces 206, 208, on a top surface 207, a bottom surface 209 or even a back surface 204 of the housing 201. In one example, the information processing system 200 may be attached to a harness worn by a pet instead of being attached to the collar portion 110. In one example, the housing 201 is made of a material that is waterproof and is hermetically sealed.

In one example, portions of the following components of the information processing system 200 (such as, but not limited to, an imager 270, a microphone 280, a speaker 290 and/or a transceiver 295) may be visible on the front surface 202. One skilled in the art would understand that the listed components of the information processing system 200 that are visible on the front surface 202 are only examples and that other components may also be visible or that some of the listed components need not be visible on the front surface 202.

In one example, the CPU 210 may include a first internal memory which is not shared with the other processing engines. In one example, the DSP 220 may include a second internal memory which is not shared with the other processing engines. In one example, any processing engine of the information processing system 200 may have an internal memory (i.e., a dedicated memory) which is not shared with any other processing engines of the information processing system 200.

The information processing system 200 may include a modem 250 to facilitate wireless connectivity and a support infrastructure 260 to provide support such as power supply, oscillators, time sources, environmental control, thermal dissipation, etc. In one example, the modem 250 performs modulation on a source information signal (e.g., video from the imager 270, audio from the microphone 280, etc.) to generate a transmit signal to be transmitted to the remote device.

In one example, the modem 250 performs demodulation on a receive signal from the remote device to generate a destination information signal (e.g., video to the imager 270, audio to the speaker 290, etc.). In one example, the wearable wireless communicator 100 includes a battery to supply power to operate the information processing system 200. In one example, the battery is a disposable battery. In another example, the battery is rechargeable. In one example, the support infrastructure 260 includes a function for monitoring battery voltage and for providing a battery voltage indication if the battery voltage is below a voltage threshold. This battery voltage indication may appear as a light indicator on the housing 201 or the battery voltage indication may be signal transmitted to a smart device associated with a human member of the pet.

In one example, the processing engines (e.g., CPU 210 and/or DSP 220) in the information processing system 200 may connect to a plurality of peripheral devices to provide additional functionality. The plurality of peripheral devices may include, for example, imager 270, microphone 280, speaker 290, etc.

In one example, the imager 270 allows capturing real-time image data or video data that may be stored in the memory 230 and/or cache memory 240, and/or transmitted wirelessly to a remote smart device (e.g., smart phone, a computer, a smart pad). In one example, the imager 270 may be a camera, an image sensor, etc. In one example, the imager 270 may be triggered to turn ON by a motion detection sensor 272 and/or an audio detection sensor 274. In one example, the motion detection sensor 272 is configured to turn ON the imager 270 when it detects a motion level above a preset motion threshold. In one example, the audio detection sensor 274 is configured to turn ON the imager 270 when it detects an audio level above a preset audio threshold.

In one example, motion detection and audio detection may be achieved by a single sensor system. In one example, the motion detection sensor 272 may use visual signals or vibration signals to detect motion. In another example, the motion detection sensor and the audio detection sensor are separate sensors. In one example, the imager 270 may be turned ON (or turned OFF) remotely by a user, or a timer (not shown) coupled to the imager 270 may be set to turn the imager ON and OFF. In one example, the motion detection sensor 272 is a component of the imager 270. In one example, the audio detection sensor 274 is a component of the imager 270.

In one example, the microphone 280 is a transducer that converts sound energy to electrical energy (e.g., an electrical signal). In one example, the speaker 290 is a transducer that converts electrical energy (e.g., an electrical signal) to sound energy. In one example, the microphone 280 provides an input signal (which is an electrical signal) to the transceiver 295 for wireless transmission to a remote device (e.g., smart phone, a computer, a smart pad). In one example, the remote device is associated with a human member of the pet wearing the wearable wireless communicator 100. In one example, the transceiver 295 receives a wireless signal from the remote device and converts the wireless signal to an electrical signal, wherein the electrical signal is transported through the databus 298 to the speaker 290 for further conversion to a sound energy.

In one example, the microphone 280 may be turned ON (or turned OFF) remotely by a user, or a timer (not shown) coupled to the microphone 280 may be set to turn the microphone ON and OFF. In one example, the microphone 280 may be triggered to turn ON by the motion detection sensor 272 and/or the audio detection sensor 274. In one example, the motion detection sensor 272 is configured to turn ON the microphone 280 when it detects a motion level above a preset motion threshold. In one example, the audio detection sensor 274 is configured to turn ON the microphone 280 when it detects an audio level above a preset audio threshold.

Once turned ON, the microphone 280 may record audio signals (i.e., sound energy) and stored them in the memory 230 and/or cache memory 240. In one example, the audio signals heard by the microphone may be transmitted via the transceiver to the remote device.

In one example, the speaker 290 converts an output of the transceiver 295 to sound energy which is then audible from the wearable wireless communicator 100. In one example, the output of the transceiver is received through wireless communication from a remote device being operated, for example, by a human family member. In one example, the transceiver 295 is a device that transmits and receives communication signals, in particular, communication signals transmitted wirelessly. In one example, the transceiver 295 may be compatible with WiFi, Bluetooth, Long Range (LoRa), etc. LoRa is a wireless technology with the ability to send small amount of data over extensive distances. In one example, the transceiver 295 includes a omni directional antenna (not shown) for transmitting and receiving information. In one example, the modem 250 may be part of the transceiver 295.

In one example, processor-peripheral device communications may be implemented by a bidirectional high-speed interface. In one example, the information processing system 200 provides the functionality of a wireless communication system for the wearable wireless communicator 100. For example, the wireless communication functionality of the information processing system 200 may conform to a wireless network protocol such as 4G LTE (long term evolution), 5G NR (new radio, etc.) and any such wireless network protocol.

In one example, the information processing system 200 includes a Global Positioning System (GPS) receiver 255. In one example, the GPS receiver 255 includes an omni directional antenna (not shown) for receiving satellite navigation signals which may be processed to provide a three-dimensional (3D) position of the host (e.g., pet) carrying the information processing system 200.

In one example, a human member may set a perimeter to outline an area the pet may roam. This perimeter setting may be accomplished by using location information from the GPS receiver and saving the location information that defines the perimeter. Alternatively, the perimeter setting may be accomplished by using an on-line mapping tool (e.g., Google maps) to define the perimeter boundary in a graphical manner.

The perimeter is then stored in the memory 230 and/or cache memory 240. In one example, the human member may use a smart device (e.g., smart phone, a computer, a smart pad) to wireless communicate with the support infrastructure 260 to define the perimeter. Once the perimeter is defined and stored in the memory 230 and/or cache memory 240, the human member may enable an alert signal to be transmitted to a smart device when there's a breach of the perimeter boundary. That is, when the pet's location is deemed to have crossed the defined perimeter, an alert signal is transmitted to a smart device to notify a human member. In one example, a human member may prepare a pre-recording of his/her voice to be activated when there is a breach of the perimeter boundary. That is, when the pet's location is deemed to have crossed the defined perimeter, the human member's voice may be transmitted through the speaker 290, for example, to say “Fido, go back inside”, etc.

In one example, the support infrastructure 260 includes an electric shock feature which may be enabled remotely by a human member to deliver an electric shock to the pet. The delivery of the electric shock may be used to keep the pet within the perimeter boundary or to coax the pet to return to within the defined perimeter.

In one example, the GPS receiver 255 may also provide an accurate time in UTC (coordinated universal time) coordinates. In one example, the real-time image data or video data captured by the imager 270 may be time-tagged using the UTC coordinates. And, in one example, the UTC coordinates may be converted to local time in reference to a local clock (not shown) in the support infrastructure 260. In one example, the conversion from UTC coordinates to local time may be performed by the CPU 210 or the DSP 220.

In one example, the plurality of components (e.g., CPU 210, DSP 220, Memory 230, cache memory 240, modem 250, GPS receiver 255, support infrastructure 260, imager 270, motion detection sensor 272, audio detection sensor 274, microphone 280, speaker 290, transceiver 295, etc.) of the information processing system 200 with their respective various other functions are interconnected by an interconnection databus 298 to transport data and control information among the plurality of components.

In one example, the plurality of components (e.g., CPU 210, DSP 220, Memory 230, cache memory 240, modem 250, GPS receiver 255, support infrastructure 260, imager 270, motion detection sensor 272, audio detection sensor 274, microphone 280, speaker 290, transceiver 295, etc.) of the information processing system 200 are all microelectronic components with minimal weight so as to accommodate a total weight requirement. The total weight of the information processing system 200 is designed to accommodate a pet's ability to wear it without causing discomfort.

Although several components of the information processing system 200 are included herein, one skilled in the art would understand that the components listed herein are examples and are not exclusive. Thus, other components may be included as part of the information processing system 200 within the spirit and scope of the present disclosure.

In one aspect, one or more of the steps for providing wireless communication may be executed by one or more processors which may include hardware, software, firmware, etc. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware for implementing wireless communication. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
an imager configured to capture image data;
a memory coupled to the imager, the memory configured to store the image data;
a transceiver coupled to the imager and the memory, the transceiver configured to wirelessly transmit the image data to a remote device;
a databus configured to transport the image data between the imager, the memory and the transceiver; and
a housing for housing the databus, the imager, the memory and the transceiver, wherein the housing is attached to a collar portion, and wherein the collar portion is configured to fit around a body part of a wearer.

2. The apparatus of claim 1, further comprising a microphone housed within the housing, the microphone configured to receive a first sound energy and to convert the first sound energy to a first electrical energy.

3. The apparatus of claim 2, wherein the transceiver is further configured to transmit the first electrical energy to the remote device.

4. The apparatus of claim 1, further comprising a speaker housed within the housing, the speaker configured to convert a second electrical energy to a second sound energy, wherein the second sound energy is set at a volume that is audible.

5. The apparatus of claim 4, wherein the transceiver is further configured to receive a wireless signal from the remote device and convert the wireless signal to the second electrical energy, and
wherein the databus is further configured to transport the second electrical energy to the speaker.

6. The apparatus of claim 2, further comprising a motion detection sensor coupled to the databus, the motion detection sensor configured to detect a motion level and further configured to turn ON one or more of the imager and the microphone when the motion level is above a preset motion threshold.

7. The apparatus of claim 6, further comprising an audio detection sensor coupled to the databus, the audio detection sensor configured to detect an audio level and further configured to turn ON one or more of the imager and the microphone when the audio level is above a preset audio threshold.

8. The apparatus of claim 7, further comprising a processing engine coupled to the databus, the processing engine configured to process image data captured by the imager or audio data captured by the microphone.

9. The apparatus of claim 8, further comprising a GPS receiver coupled to the databus, the GPS receiver configured to provide a three-dimensional (3D) position of housing.

10. The apparatus of claim 9, wherein the processing engine is further configured to use the 3D position to determine if the housing is within a set perimeter boundary.

11. The apparatus of claim 10, further comprising a modem coupled to the databus, the modem configured to perform modulation on a source information signal to generate a transmit signal to be transmitted to the remote device.

12. The apparatus of claim 11, further comprising a support infrastructure with an electric shock feature, the support infrastructure coupled to the data bus and configured to deliver an electric shock to the collar portion.

13. The apparatus of claim 12, wherein the electric shock is delivered only when the housing is not within the set perimeter boundary.

14. The apparatus of claim 12, wherein the electric shock is delivered when triggered by a signal received from the remote device.

15. The apparatus of claim 12, further comprising a buckle, a clasp and a ring, each separately attached to a distinct area of the collar portion.

16. The apparatus of claim 10, further comprising a modem coupled to the databus, the modem configured to perform demodulation on a receive signal from the remote device to generate a destination information signal.

17. The apparatus of claim 16, wherein the transceiver is further configured to wirelessly receive a wireless signal from the remote device and to output a receive signal.

18. The apparatus of claim 17, wherein the modem is further configured to demodulate the receive signal to generate a second electrical energy.

19. The apparatus of claim 18, wherein the speaker is further configured to convert the second electrical energy to a second sound energy for communicating with the wearer.

20. The apparatus of claim 19, further comprising a buckle, a clasp and a ring, each separately attached to a distinct area of the collar portion.
